(19) United States
(12) Patent Application Publication
(10) Pub. No.: US 2026/0043726 A1
(43) Pub. Date: Feb. 12, 2026

(54) METHOD FOR NON-DESTRUCTIVE MEASUREMENT OF WAFER BONDING STRENGTH

(71) Applicant: Dongguan Attach Point Intelligent Equipment Co., Ltd., Dongguan City (CN)

(72) Inventors: Shubin Chen, Dongguan City (CN); Huansu Xu, Dongguan City (CN); Quanbin Chen, Dongguan City (CN)

(21) Appl. No.: 18/909,981

(22) Filed: Oct. 9, 2024

(30) Foreign Application Priority Data
Aug. 9, 2024 (CN) 2024110914559

(51) Int. Cl. G01N 3/22; G01N 3/08

(52) U.S. Cl. CPC G01N 3/22; G01N 3/08; G01N 2203/0019; G01N 2203/0021; G01N 2203/0062; G01N 2203/0282; G01N 2203/0682

(57) ABSTRACT

The method for non-destructively measuring the bonding strength of wafers comprises the following steps: Step 1: placing two wafers that have been bonded on a working platform, wherein the first wafer located at the bottom is fixed to the surface of the working platform; Step 2: applying pressure and tension to the second wafer located at the top at different regions thereof at the same time; Step 3: a crack is generated between the second wafer and the first wafer under the pressure and tension; Step 4: after the crack is formed, spraying water mist into the crack to allow the water mist to penetrate into the crack; Step 5: measuring the size of the crack and calculating the bonding strength of the wafer according to the following formula: γ=3Et³y²/32L⁴.

### BACKGROUND OF INVENTION

### Field of the Invention

The present invention relates to the technical field of wafer detection methods, in particular a method for non-destructive measurement of wafer bonding strength.

### Description of Related Art

Low-temperature wafer direct bonding technology is the most popular bonding method in recent years, but it is also very difficult. This is because it has the highest requirements for silicon wafer surface morphology and surface treatment process. Poor silicon wafer surface morphology or surface treatment will cause irreparable defects in the bonded wafer pair. The process of wafer direct bonding has gone through the process from early high-temperature wafer bonding to the currently widely studied and promoted low-temperature wafer bonding. The main purpose is to overcome the influence of high temperature on devices, so people began to focus on the research of low-temperature wafer bonding. The main research currently includes hydrophilic bonding and hydrophobic bonding. The essence of low-temperature direct bonding is to improve the surface energy by treatment of the silicon surface, and then bond two or more silicon wafers together through water molecule bridging (hydrophilic bonding) or HF molecule bridging (hydrophobic bonding) and intermolecular forces.

In low-temperature wafer direct bonding technology, bond strength is one of the most important measurement characteristics and an important indicator related to the quality of bonding. If the bond strength is low, the two bonded wafers are likely to crack during processing, resulting in failure. Slight changes in manufacturing process parameters (especially the surface pretreatment steps and bonding conditions of the wafer) will directly affect the strength performance of the bonding interface. Therefore, insufficient bond strength reflects that there is a problem in some aspects of the bonding process; high bond strength proves that the two wafers are in close contact, and the impact of cracks and voids on the bonding interface is minimal. Devices made using bonding technology are also less susceptible to failure due to environmental factors such as temperature and humidity.

At present, commercial bond strength measurement methods all use destructive measurement methods, including crack propagation and diffusion method, straight pull method, micro wedge groove test method, static oil pressure test method and four-point bending test method, among which the crack propagation and diffusion method is the most commonly used. For example, the Chinese invention patent application with patent number 201811368336.8 discloses “a method for measuring bonding strength and a bonded wafer using the same”. This technical solution is to use the crack propagation and diffusion method, commonly known as the blade insertion method. This is the most traditional and common method for measuring bonding strength. It separates the two wafers by inserting a thin blade at the bonding interface. The crack length obtained by this technical solution is a representation of the bonding strength. However, in this method, the thin blade will cause serious damage to the wafer, which is a destructive measurement method. The bonding energy is related to the crack length, blade thickness, wafer thickness and blade insertion speed, and the thin blade will cause serious damage to the wafer, resulting in the scrapping of the wafer, so it is very disadvantageous in terms of accuracy and cost.

In summary, in low-temperature wafer direct bonding technology, bonding strength is one of the most important measurement characteristics and an important indicator related to the quality of bonding. However, the current commercial bonding strength measurements all use destructive measurement methods, resulting in a high wafer scrap rate. In view of this, the inventor proposes the following technical solutions in combination with the deficiencies of the prior art.

### SUMMARY OF THE INVENTION

The technical problem to be solved by the present invention is to overcome the deficiencies of the prior art and propose a method for non-destructively measuring the bonding strength of wafers.

In order to solve the above technical problems, the present invention adopts the following technical solutions: The method for non-destructively measuring the bonding strength of wafers comprises the following steps: Step 1: placing two wafers that have been bonded on a working platform, wherein the first wafer located at the bottom is fixed to the surface of the working platform; Step 2: applying pressure and tension to the second wafer located at the top at different regions thereof at the same time; Step 3: a crack is generated between the second wafer and the first wafer under the pressure and tension; Step 4: after the crack is formed, spraying water mist into the crack to allow the water mist to penetrate into the crack; Step 5: measuring the size of the crack and calculating the bonding strength of the wafer according to the following formula: γ=3Et³y²/32L⁴.

Further, in the above technical solution, said first wafer is fixed to the surface of the working platform by vacuum adsorption, that is, pores are distributed on the surface of the working platform, and said first wafer is adsorbed on the surface of the working platform by forming a vacuum or negative pressure at the pores.

Further, in the above technical solution, said first wafer is fixed to the surface of the working platform by mechanical clamping, that is, a positioning groove is formed on the surface of the working platform, and said first wafer is clamped in the positioning groove.

Further, in the above technical solution, the tension position F1 acting on the second wafer is close to the edge, the pressure position F2 acting on the second wafer is far away from the tension position F1, and the distance between the two is greater than the length L of the crack.

Further, in the above technical solution, in the step 5, the size of the crack is measured by infrared detection or ultrasonic detection.

Further, in the above technical solution, another technical problem to be solved by the present invention is to propose a device for non-destructively measuring the bonding strength of wafers according to the above technical solution, the device comprising: a working platform, said working platform is used to place two wafers that have been bonded, and said working platform has a vacuum adsorption or mechanical positioning device to fix the first wafer located below to the surface of the working platform; a pressure mechanism, said pressure mechanism is located on the working platform, and the two wafers on the working platform are pressed down by said pressure mechanism; a tension mechanism, said pressure mechanism is located on the working platform, and said tension mechanism acts on the second wafer located above to form an upward tension on it; a spray mechanism, said spray mechanism is located on the side of the working platform; a detection device, said detection device is an infrared detector or an ultrasonic detector.

After adopting the above technical solution, the present invention has the following beneficial effects compared with the prior art:

First, the present invention refers to the existing blade insertion method, but does not need to use a blade, thereby avoiding destructive measurement caused by blade insertion and avoiding the cost problem caused by wafer scrapping.

Secondly, after adopting the measurement method of the present invention, the measurement error caused by the inconsistent factors such as the blade insertion speed and angle in the existing blade insertion method can be avoided.

In short, the non-destructive method for measuring the bonding strength provided by the present invention allows accurately measuring the bonding strength without destroying the wafer, so it is very advantageous in terms of accuracy and cost.

### BRIEF DESCRIPTION OF THE DRAWINGS

FIG. 1 is a working principle diagram of the present invention;

FIG. 2 is a schematic diagram of the first embodiment of the device in the present invention;

FIG. 3 is a schematic diagram of the second embodiment of the device in the present invention.

### DETAILED DESCRIPTION OF THE INVENTION

The present invention is further described below in combination with specific embodiments and drawings.

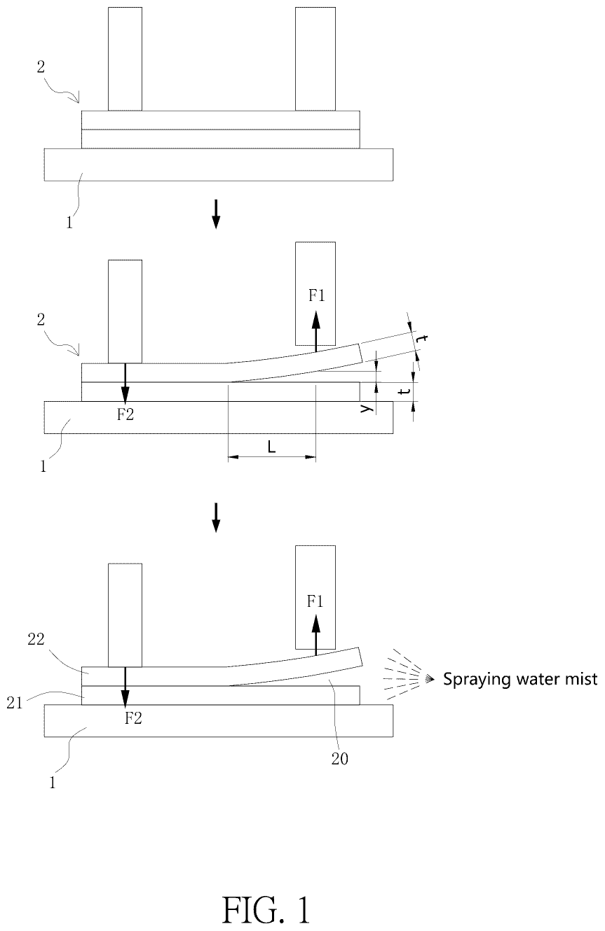

As shown in FIG. 1, this is a working principle diagram of the method for non-destructive measurement of wafer bonding strength used in the invention. The method comprises the following steps:
Step 1: Place the bonded wafer 2 on the working platform 1, wherein the first wafer 21 located below is fixed to the surface of the working platform 1. In this step 1, the first wafer 21 can be fixed to the working platform 1 by vacuum adsorption. This method will not damage the first wafer 21 and ensure the integrity of the first wafer 21 to the greatest extent possible.
Step 2: Apply pressure and tension to different regions of the second wafer 22 located above. By applying pressure to form a pressing force and a pressing fulcrum relative to the pulling force, the second wafer 22 is pressed on the first wafer 21, so that the bonded wafer 2 will not be directly separated from the working platform under the action of the pulling force. The applied pressure should not cause compression damage to the wafer, but simply press the wafer.

Said pressure and tension act on different regions of the second wafer 22 respectively, and in order to facilitate the generation of cracks, the tension position F1 acting on the second wafer 22 should be close to the edge of the second wafer 22. At the same time, the pressure position F2 acting on the second wafer 22 is far away from the tension position F1, and usually the pressure position F2 and the tension position F1 are located on opposite sides of the second wafer.
Step 3: As the tension increases, the pressure position F2 at one end of the second wafer 22 is subject to the pressure, and the tension position F1 at the other end is deformed under the tension, and within the elastic deformation range, a crack 20 is generated between the second wafer 22 and the first wafer 21. The distance between the pressure position F2 and the tension position F1 is greater than the length L of the crack, that is, the crack 20 cannot overlap with the pressure position F2, or it will affect the crack length and cause the measurement result to fail. If the crack overlaps with the pressure position F2, it can be improved by reducing the pulling height of the tension or adjusting the pressure position F2.
Step 4: After the crack 20 is formed, spray water mist into the crack 20 to allow the water mist to penetrate into the crack 20. Spraying water mist or other liquid substances into the crack is to facilitate the subsequent measurement of the size of the crack. Because the crack length will be obtained later using an infrared camera or an ultrasonic microscope, and different substances will have different reflection and penetration behaviors under infrared light or ultrasound, the crack length can be observed in its image.
Step 5: Measure the size of the crack 20 through infrared detection or ultrasonic detection, and calculate the wafer bonding strength according to the following formula:

$$γ = 3 {Et}^{3} {y}^{2} / 32 {L}^{4} ,$$

where
γ is the wafer bonding strength;
E is the Young's modulus of a single wafer;
t is the thickness of a single wafer;
y is the height of the second wafer being stretched;
L is the length of the crack;

Wherein, the length of the crack L is the distance from the center of the tension position F1 to the deepest part of the crack, and the height y of the second wafer being stretched is the pulling height at the center of the tension position F1.

The present invention refers to the existing blade insertion method, but does not require the use of a blade, thereby avoiding destructive measurements caused by blade insertion and avoiding cost issues caused by wafer scrapping. At the same time, after adopting the measurement method of the present invention, the measurement error caused by inconsistent factors such as the artificial blade insertion speed and angle in the existing blade insertion method can be avoided.

The wafer 2 after the bonding strength measurement is completed by the present invention can be reused after the debonding process and surface cleaning to avoid waste.

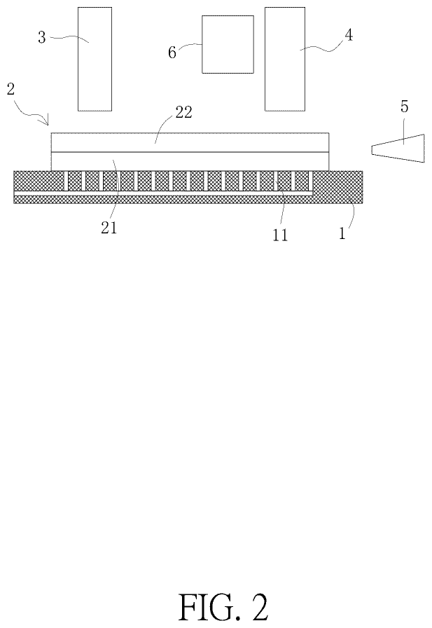

According to the above-mentioned measurement method of the present invention, a corresponding measurement device can be designed, as shown in FIG. 2, the device comprise: a working platform 1, a pressure mechanism 3, a tension mechanism 4, a spray mechanism 5 and a detection device 6.

Said working platform 1 is used to place two wafers 2 that have been bonded, and said working platform 1 has a vacuum adsorption device to fix the first wafer 21 located below to the surface of the working platform 1. As shown in FIG. 2, the vacuum adsorption device is realized by pore 11 distributed on the surface of the working platform 1, and said pore 11 is connected to an external vacuum air pump, and the first wafer is adsorbed on the surface of the working platform by forming a vacuum or negative pressure at the pore 11.

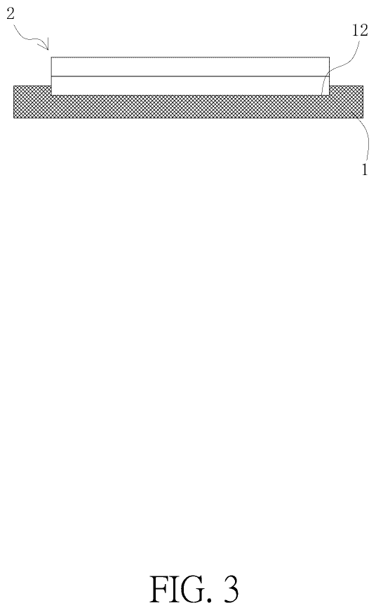

This vacuum adsorption method will not cause damage or destruction to the wafer. Of course, other mechanical methods can also be used, for example, as shown in FIG. 3, which is a schematic diagram of the second embodiment of the present invention. In this second embodiment, said first wafer is fixed to the surface of the working platform 1 by mechanical clamping, that is, a positioning groove 12 is formed on the surface of the working platform 1, and said second wafer 21 is clamped in said positioning groove 12. Of course, the first wafer can also be fixed by means of mechanical clamps. The present invention gives priority to the fixing method of vacuum adsorption.

Said pressure mechanism is located on the working platform 1, which can be a cylinder or a hydraulic cylinder, or a connecting rod mechanism, and is installed above the working platform, and the wafer 2 of the working platform 1 is pressed by the pressure mechanism 3.

Said pulling mechanism 4 is also located on the working platform 1, and the pulling mechanism can be a cylinder or a hydraulic cylinder mechanism. The pulling mechanism 4 acts on the second wafer located above to form an upward pulling force on it. The connection between the pulling mechanism 4 and the second wafer can also be a vacuum adsorption method, that is, a vacuum suction head is set at the end of the pulling mechanism 4, and the second wafer is pulled by vacuum adsorption. Of course, the connection between the pulling mechanism 4 and the second wafer 22 can also be achieved by adhesive bonding.

Said spray mechanism 5 is located on the side of the working platform 1, and is used to spray water mist or other liquids to the crack.

Said detection device 6 is an infrared detector or an ultrasonic detector. It can be directly set above the workbench and moved by a mechanical arm, or it can be set as an independent component separated from the workbench. When testing, the wafer is taken out from the working platform 1 and placed in the detection device 6 for testing.

Of course, the above is only a specific embodiment of the present invention, and is not intended to limit the scope of implementation of the present invention. Any equivalent changes or modifications made according to the structure, features and principles described in the scope of the patent application of the present invention should be included in the scope of the patent application of the present invention.

What is claimed is:

1. A method for non-destructively measuring the bonding strength of wafers comprises the following steps:
placing two bonded wafers on a working platform, with the first wafer located at a bottom fixed to a surface of the working platform;
applying pressure and tension simultaneously at different regions to the second wafer located on top;
generating a crack between the second wafer and the first wafer under the applied pressure and tension;
spraying water mist into the crack after the crack is formed to allow the water mist to penetrate into the crack;
measuring the size of the crack and calculating the bonding strength of the wafer using the following formula
$$γ = \frac{3 {Et}^{3} {y}^{2}}{32 {L}^{4}}$$
where:
γ is the wafer bonding strength;
E is the Young's modulus of a single wafer;
t is the thickness of a single wafer;
y is the height of the second wafer being stretched;
L is the length of the crack.

2. The method for non-destructively measuring the bonding strength of wafers according to claim 1, wherein the first wafer is fixed to the surface of the working platform by vacuum adsorption, that is, pores are distributed on the surface of the working platform, and the first wafer is adsorbed on the surface of the working platform by forming a vacuum or negative pressure at the pores.

3. The method for non-destructively measuring the bonding strength of wafers according to claim 1, wherein the first wafer is fixed to the surface of the working platform by mechanical clamping, that is, a positioning groove is formed on the surface of the working platform, and the first wafer is clamped in the positioning groove.

4. The method for non-destructively measuring the bonding strength of wafers according to claim 1, wherein the tension position F1 acting on the second wafer is close to the edge, the pressure position F2 acting on the second wafer is far away from the tension position F1, and the distance between the two is greater than the length L of the crack.

5. The method for non-destructively measuring the bonding strength of wafers according to claim 1, in the step 5, the size of the crack is measured by infrared detection or ultrasonic detection.

6. The method for non-destructively measuring the bonding strength of wafers according to claim 1, comprises that the device for implementing the method includes:
a working platform, the working platform is used to place two wafers that have been bonded, and the working platform has a vacuum adsorption or mechanical positioning device to fix the first wafer located below to the surface of the working platform;
a pressure mechanism, the pressure mechanism is located on the working platform, and the two wafers on the working platform are pressed down by the pressure mechanism;
a tension mechanism, the pressure mechanism is located on the working platform, and the tension mechanism acts on the second wafer located above to form an upward tension on it;
a spray mechanism, the spray mechanism is located on the side of the working platform;
a detection device, the detection device is an infrared detector or an ultrasonic detector.
